(19) United States
(12) Patent Application Publication
(10) Pub. No.: US 2005/0061129 A1
(43) Pub. Date: Mar. 24, 2005

(54) Tool and method for its manufacture

(76) Inventors: Bengt Berg, Oloestrom (SE); Christer Svensson, Jamshog (SE)

Correspondence Address: Gregory A Coury;Bachman & LaPointe, Suite 1201, 900 Chapel Street, New Haven, CT, 06510, US

(21) Appl. No.: 10/495,396

(22) PCT Filed: Nov. 12, 2002
(86) PCT No.: PCT/SE02/02064

(30) Foreign Application Priority Data
Nov. 13, 2001 (SE) 0103769

(51) Int. Cl. B26D 7/20

(52) U.S. Cl. 83/658

(57) ABSTRACT

A tool or a part thereof which has at least one tool body (7, 8) and one functional part (9) is cast in one united piece with at least two different casting materials (18, 20) of different material compositions, whereby the different parts of tool possess different material properties. Between the different tool parts, there is a clear interface in the material composition, but an intermingled transitional zone (19) of different material compositions is possible. In a method of manufacturing the tool, or a part thereof, casting material of at least two different material compositions is supplied to different parts (7, 8, 9, respectively) of the tool. The casting materials are kept separate and discrete from one another and, after the casting, there is thus obtained a tool possessing different material properties in different parts (7, 8; 9) of the tool.

### TECHNICAL FIELD

The present invention relates to a tool or a part thereof for carrying out operations such as pressing, cutting, hemming and the like and includes at least a first and a second tool part with different functions in the tool, for example a tool body and an functional part disposed thereon in order, alone or together with some other additional functional part, or additional tool, to carry out the operation, the first and the second parts possessing different material properties.

The present invention also relates to a method for manufacturing a tool or a part thereof, for carrying out operations such as pressing, cutting, hemming and the like, and entails that the tool is given different material properties in different parts of the tool.

### BACKGROUND ART

In the manufacture of a tool for the above-outlined purpose, it has previously been the practice to separately manufacture a tool body which subsequently, in the example of a cutting tool, is provided with one or more cutters. The manufacture of the tool body may be put into effect by casting or by welding on the basis of suitably dimensioned sheet material of appropriately adapted material composition.

In the case of a cast tool body, this often requires heat treatment after the casting, whereafter machining is put into effect in order to obtain the requisite seats, guide pins and bolt holes for securing the cutters, but also in order to make possible securing of the tool body in a machine.

Correspondingly, in the alternative of welding of the tool body, extensive machining is required in order to be able to secure one or more cutters on the tool body and in the correct position, and in order to be able to secure the tool in a machine.

In the manufacture of the functional part or parts, in the above-disclosed example the cutters, which are intended for carrying out the operations for which the tool has been designed, the point of departure has previously often been rod or bar material in which event the functional parts, in this example the cutters, are machined to the correct configuration, provided with apertures and anchorage bolts, guide pins and the like. This is often followed by a heat treatment, whereafter further machining such as, for example, grinding, is put into effect.

To manufacture a tool in the above-outlined manner is extremely time-consuming and such manufacture is, as a result, often determinative of the time consumption required in the new manufacture of different products.

It is also previously known in the art, in the manufacture of tools by welding, flash welding and similar methods, to apply a material of a different composition, for example to a tool body so that a functional part is formed thereon. By such means, a tool will be obtained which consists of a single material piece, but in which the material composition in different parts thereof differs.

Also in this alternative, extensive machining is required, for example in the form of joint preparation in welding and after-treatment of a weld before additional welding material can be applied. When the material application is completed, further machining is required, possibly also heat treatment and subsequent grinding before the tool is ready to be made operational.

When a tool has become obsolescent, for example because the part which is produced m the tool has itself become obsolete, or because the tool has quite simply become worn out, the entire tool is scrapped, even though the tool body could very well be re-used. This naturally entails a waste of material, time and money.

Problem Structure

The present invention has for its object to obviate the drawbacks inherent in the prior art technology. Principally, the present invention has for its object to shorten the production time for a tool, but also to minimise the need of machining in the manufacture of the tool and to make possible the retro-construction of an obsolescent tool.

Concerning the tool, the present invention has for its object to design the tool or a part thereof such that different parts of the tool display different material compositions adapted so as to impart to the different parts their intended material properties.

Concerning the method, the present invention has for its object to propose a method for the manufacture of a tool or a part thereof in which different parts of the tool may be given different material compositions and, consequently, different material properties.

Solution

The objects forming the basis of the present invention will be attained concerning the tool is this is characterised in that the first and the second tool parts are cast in one united piece and that they possess different material compositions.

The objects forming the basis of the present invention will be attained concerning the method if this is characterised in that the tool is cast in one united piece, the casting material of at least two different material compositions being supplied to the different parts of the tool and at least the one cog material being supplied in liquid form.

### BRIEF DESCRIPTION OF THE ACCOMPANYING DRAWINGS

The present invention will now be described in greater detail hereinbelow, with reference to the accompanying Drawings. In the accompanying Drawings:

FIG. 1 is a cross section through a part of a tool, in this case a cutting tool;

FIG. 2 is a partial cross section, on a larger scale, through a part marked by means of the arrow A of the tool of FIG. 1; and

FIG. 3 is a cross section through a mould for manufacturing a tool according to the present invention.

### DESCRIPTION OF PREFERRED EMBODIMENT

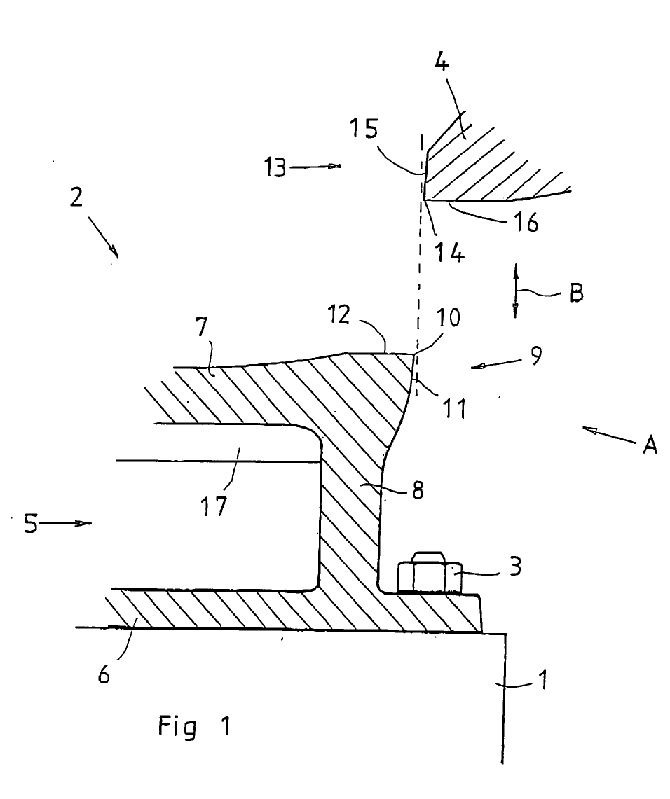

In FIG. 1, reference numeral 1 relates to a machine bed or foundation on which the tool 2 is secured by means of a bolt union 3.

The tool illustrated in FIG. 1 by way of example is a cutting tool which is in two parts and consists therefore of two tool parts, a lower tool part 2 and an upper tool part 4. The tool parts 2 and 4 are, however, in this context considered as separate tools.

A tool may be thought of as being composed of a plurality of different components, for example a tool body and a functional part in the illustrated example, the functional part would consist of a cutter which is intended to carrying out the processing operation together with a corresponding functional part on the upper tool 4.

In FIG. 1, the tool 2 includes a tool body 5 which has a lower mounting plate 6 for securing the tool on the tool table or bed 1. Further, the tool body 5 includes an upper part 7 which, in the illustrated embodiment, has rigidification ribs 17. The upper part 7 is connected to the anchorage plate 6 by the intermediary of a wan portion 8.

The tool 2 illustrated in FIG. 1 has a functional part 9 which is intended to realise the cutting operation proper and which is supported by and is of one piece manufacture with the tool body 5. The functional part 9 has an edge 10, a flank or rake 11 and a surface 12 on which the workpiece is supported during a cutting operation.

Correspondingly, the upper tool 4 has a functional part 13 with an edge 14, a flank or rake 15 and a surface 16 for abutment it the workpiece.

When the tool is in operation, the workpiece rests on the tool 2, in particular on its upwardly facing surface 12, and extends more or less outside the edge 10 in a direction to the right in FIG. 1. In one working stroke, the upper tool 4 moves according to the arrow B so far down that the edge 14 passes down to or slightly past the edge 10. Thus, during the working operation, it is both of the functional parts 9 and 13 tat realise the working operation, in this case the cutting operation.

It will readily be perceived that the two edges 10 and 14, as well as surrounding parts of the tools, must display superior mechanical strength, both toughness and hardness, as well as in addition an ability to produce relatively sharp edges. This is a requirement which the tool body 5 by no means needs to satisfy but, as regards the tool body proper, it is properties such as, for example, vibration damping and slight outward flexing which are more important than those properties that are required for carrying out the working operation itself. For this reason, both of the functional parts 9 and 13 possess totally different material properties than does the tool body 5.

In actual fact, different material properties could be achieved in a tool which, in its entirety, consists of one and the same material, but in which different parts of the tool are treated in different ways, for example by heat treatment. However, this implies a limitation in those differences in material properties that may be attained and, on the other hand, unnecessary costs since probably one material which is appropriate for one functional part may be considered as overqualified in a tool body.

According to the present invention, those parts of a tool which, because of different functional requirements, possess different material properties, also have a different composition of the material lying behind the different material properties.

In the manufacture of a tool according to the present invention, this is cast from at least two different casting materials of different material compositions into one united piece. The term casting is taken to signify that a liquid casting material is supplied into a mould where the cast material is allowed or caused to harden into a casting whose form is defined by the form of the mould cavity which is enclosed in the mould. The casting operation may be put into effect such that a clear and sharp interface between the different casting materials is achieved, or alternatively the casting operation may be put into effect so that a certain intermingling of the two casting materials takes place in an interface zone.

In the casting operation so that a sharply defined interface occurs, the first cast part of the tool is allowed to harden so far that no intermingling of the casting materials occurs. Alternatively, use may be made of a tool part which is cast in a separate process or which has been recovered and recycled from an old, obsolete tool and which, in the heated state (600-750° C.) is inserted in a mould where an additional tool part is cast on.

In the casting so that an interface zone is formed between the tool parts, the hardening and cooling of the first cast tool part is allowed to continued only so far that a limited intermingling of the cast materials can take place or that a certain remelt of the already cast tool part can take place. The positive cooling or rest cooling of the cast material which was cast first may also be put into effect in a directed fashion, so that a hardening zone migrates through the casting and finally arrives at that side of the tool part where the additional casting-on is to take place.

In casting according to the present invention, sand foundry casting is often employed where the mould cavity at the beginning of the casting operation is filled by a template or model which is broken down and vaporised on the supply of the hot and liquid casting material. The model can, for example, be produced from expanded polystyrene. The material from the model floats up on the casting material and is accumulated uppermost on it where it may cause local deterioration in quality in the casting material. For this reason, the mould is oriented in such a manner and the tool parts are cast in such a sequence that the local deterioration in quality will have as slight consequences as possible. In particular, it is to be ensured that the local deterioration in quality of the casting material is located at a distance from the functional surface of the functional parts, i.e. that surface on the tool which carries out the function proper of the tool.

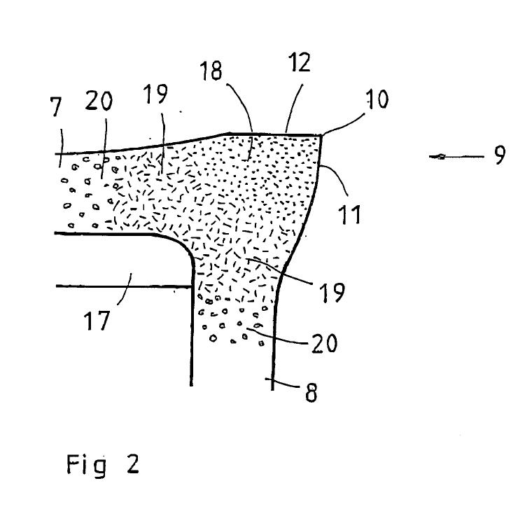

FIG. 2, which shows a partial magnification of the functional part 9 and thereby the area A of the tool 2 in the proximity of the edge 10, shows a dotted area 18 and a dashed area 19 where the two areas 18 and 19 display different material compositions. In FIG. 2, the interface between the two areas 18 and 19 is clearly marked and can, in a practical version, amount to an extremely thin interface layer or strata between the two areas.

However, if a more continuous transition between the areas 18 and 19 is desirable, it is possible in the manufacture of the tool, to intermingle, in an interface zone between the areas 18 and 19, both of the different materials from the are 18 and 19.

FIG. 2 further shows a third area 20 which, in the Drawing, is marked by ringlets. This third area 20 is thereby intended to have yet another, third material composition and consequentially different material properties than those possessed by the functional parts in the areas 18 and 19. For example, the area 20 marked by the ringlets may consist of a relatively cheap material which is employed for the greater part of the tool body 5.

In order to ensure that at least the functional part 9 possesses accurately controllable material properties, use is made of a casing material in granulate form and of high purity, as well as an analysis of small tolerances.

Those parts 9 and 13 of the tool which carry out the working operation proper, the functional parts, should possibly undergo, after the casting operation, a minor machining operation to the intended tolerances and grinding finish Possibly, these parts may also be heat treated so that the material properties will be those intended in the end product. Correspondingly, the functional parts may be provided with a coating of a material comprising yet a further different composition.

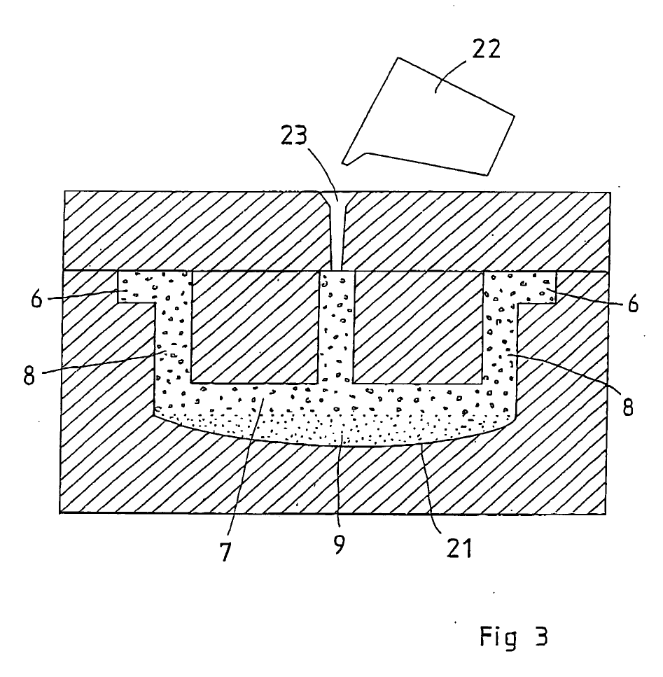

FIG. 3 shows a vertical cross section through one example of a mould which may be employed for the production of a tool according to the present invention. In the Figure, the tool is shown as ready-cast in the inverted state and it will be apparent that the tool has an anchorage plate 6, side walls 8 and an upper region 7. The previously named parts of the tool may be considered as a tool body which, for example, may be cast in a material of relatively low quality.

In its upper region (that turned to face downwards in the Figure), the tool has a functional part 9 which is cast from a material possessing different composition than the tool body and which has those properties that are needed in the functional surface 21 of the tool, i.e. that surface which produces the forming function of the tool.

It will further be apparent from the Drawing that there is an interface zone between the functional part 9 and the tool body where the two cast materials meet one another.

Before the casting of the tool according to FIG. 3, it may be assumed that the mould cavity of the mould was filled by a model or template consisting of expanded polystyrene. In the casting, the material for forming the functional part 9 is first cast from the ladle 22 down into the gate 23 of the mould. In this instance, the hot and molten casting material will vaporise and break down that part of the model which is in contact with the casting material. This material thus finds no difficulty in penetrating through the model and in arriving at the lower surface of the mould where the functional surface 21 of the tool is formed. The degradation products from the model float upwards on the casting material and, as a result, may possibly bring about a local deterioration in the quality therein.

When the functional part 9 has been cast and allowed to harden wholly or partly, depending on the desired interface zone between the functional part and the tool body, the material for forming the tool body is supplied via the gate 23. In this instance, remaining parts of the model will be broken down and vaporised as well as float upwards in the mould. The local deterioration of the material quality which the material of the model per se may possibly cause will, as a result, arrive uppermost in the mould, i.e. in the anchorage plate 6 of the tool where any possible deterioration in quality will have as slight consequences as possible.

The present invention also embodies the possibility that an existing but obsolescent tool may at least partly be recycled and reused In this instance, the existing tool is cleaned, whereafter its functional part is removed, e.g. by being milled or ground off. A fully usable tool body will remain, which is to be provided with a new functional part.

The functional part may be realised in that a block of expanded polystyrene is secured to the processed tool body, whereafter a template or model for the functional part is formed by the block. Thereafter, a mould is produced which on the one hand encloses a mould cavity for the new functional part and on the other hand at least a part of the old tool body, the tool body being located uppermost and the mould cavity lowermost. The mould has a gate whose lower end discharges in the interface zone between the tool body and the mould cavity. Possibly, the model or template may be left in place in the mould cavity.

On casting of the new functional part, if the model is sit in place in the mould cavity, it will be vaporised and the residue will float up on the casting material. This implies that any possibly negative effect on the casting material which may be caused by the residual products from the model will be located a distance from the working surface of the functional part and, more precisely, in an interface zone between the old tool body and the new functional part.

On casting a new functional part on an old tool body, it is crucial that the tool body be heated to a temperature suitable for casting on, often of the order of magnitude of 650-700° C. As a result, the mould is provided with a heating device. Alternatively, the tool body may be provided with a heating device or be pre-heated beforehand.

Once the casting of the new functional part is finished, the tool is removed from the mould and the functional part cleaned and sand blasted thereafter, possible later heat treatment and fine-adjustment of the working surface may be put into effects

1. A tool or a part thereof for carrying out operations such as pressing, cutting, hemming and the like including at least a first (5) and a second (9, 13) tool part with different functions in the tool, for example a tool body and an functional part disposed thereon in order, alone or together with some other additional functional part, or additional tool, to carry out the operation, the first and the second parts possessing different material properties, characterised in that the first (5) and the second (9, 13) tool parts are cast in one united piece and that they are of different material compositions.

2. The tool as claimed in claim 1, characterised by an additional tool part which is cast to one piece with the first (5) and the second (9, 13) tool parts; and that the additional tool part is of a material composition which differs from the material composition in the first and the second tool parts.

3. The tool as claimed in claim 1, characterised in that there is disposed, between two tool parts (5; 9; 13) of different material compositions, a clear interface between the parts.

4. The tool as claimed in claim 1, characterised in that there is a zone between two tool parts (5; 9, 13) of different material compositions, a zone consisting of material of intermingled material composition.

5. A method of manufacturing a tool or a part thereof for carrying out operations such as pressing, cutting, hemming and the like, and in which the tool is given different material properties in different parts of the tool, characterised in that the tool is cast to one united piece, the casting material with at least two different material properties being supplied, one to each of the different parts of the tool, and at least one of the casting materials being supplied in liquid form.

6. The method as claimed in claim 5, characterised in that, in the casting operation of the tool, casting materials of different compositions are kept separate and discrete from one another.

7. The method as claimed in claim 5, characterised in that, in the casting of the tool, casting materials of different compositions are intermingled in a zone between parts of the tool, where the material composition differs.

8. The method as claimed in claim 5, characterised in that at least one of the tool parts is heat treated.

9. The method as claimed in claim 5, characterised in that at least one of the tool parts is provided with a surface coating.
